(19) United States
(12) Patent Application Publication
(10) Pub. No.: US 2026/0252008 A1
(43) Pub. Date: Aug. 27, 2026

(54) IMAGE PROCESSING APPARATUS

(71) Applicant: BROTHER KOGYO KABUSHIKI KAISHA, Nagoya (JP)

(72) Inventor: Kunihiro AMANO, Kitanagoya (JP)

(21) Appl. No.: 19/544,563

(22) Filed: Feb. 19, 2026

(30) Foreign Application Priority Data
Feb. 27, 2025 (JP) 2025-029966

(51) Int. Cl. G03G 15/00; H02P 8/00

(52) U.S. Cl. CPC G03G 15/50; H02P 8/00

(57) ABSTRACT

An image processing apparatus includes a motor, a motor driver connected to the motor for driving the motor, a main controller connected with the motor driver via a plurality of first signal lines, and a sub-controller having lower processing capability than processing capability of the main controller. The sub-controller is connected with the motor driver via at least one second signal line and with the main controller via at least one third signal line.

### REFERENCE TO RELATED APPLICATIONS

This application claims priority from Japanese Patent Application No. 2025-029966, filed on February 27, 2025. The entire content of the priority application is incorporated herein by reference.

### BACKGROUND ART

An image reading apparatus with a single controller, which controls various functions including a motor driver, has been suggested.

### SUMMARY

There may be a case where the controller in the suggested image reading apparatus is required to control more functions than the originally controllable functions. In such a case, due to shortage of terminals or internal functions in the controller, the controller may be expansively provided with an external controller.

When the externally expanded controller is provided with functions for processing both high-speed and complicated signals and low-speed and simple signals, the manufacturer may need to select a relatively high-performance and high-priced controller for the externally expanded controller.

The present disclosure is advantageous in providing a technology that may contribute to cost reduction when expanding the number of terminals in a controller.

According to an aspect of the present disclosure, an image processing apparatus includes a motor, a motor driver connected to the motor for driving the motor, a main controller connected with the motor driver via a plurality of first signal lines, and a sub-controller having lower processing capability than processing capability of the main controller. The sub-controller is connected with the motor driver via at least one second signal line and with the main controller via at least one third signal line.

### BRIEF DESCRIPTION OF DRAWINGS

FIG. 1 is a schematic cross-sectional view of a multifunction peripheral.

FIGS. 2A-2B are a diagram to illustrate exemplary signals exchanged between a main controller and a sub-controller for controlling the multifunction peripheral shown in FIG. 1.

FIG. 3 is a flowchart to illustrate a procedure in a motor-driver controlling process executed by the main controller.

FIG. 4 is a flowchart to illustrate a procedure in a setting process executed by the sub-controller.

### DESCRIPTION

Hereinafter, an illustrative embodiment of the present application will be described in detail with reference to the drawings.

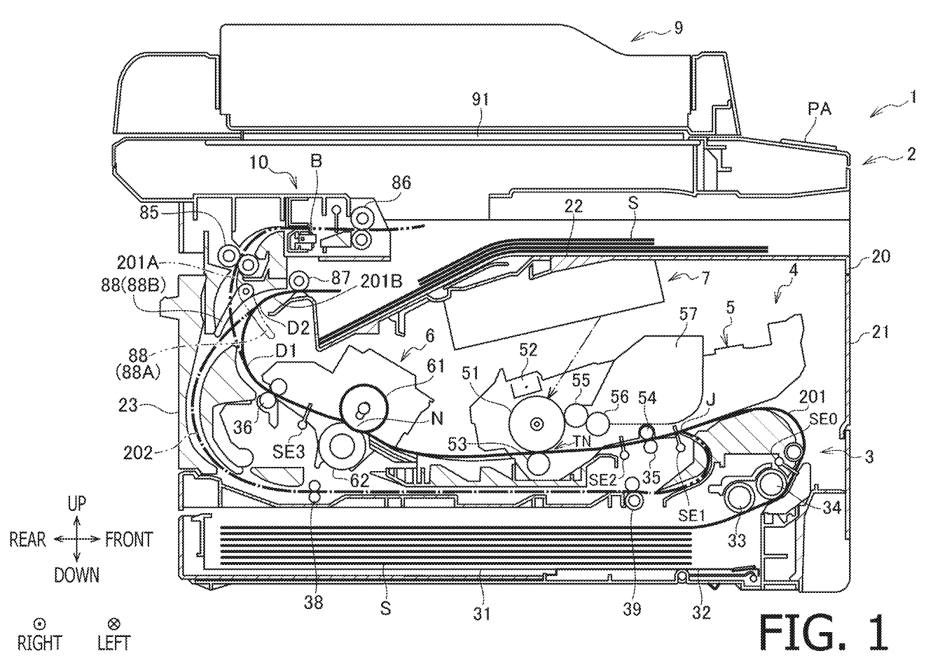

FIG. 1 is a schematic cross-sectional view of a multifunction peripheral 1. The multifunction peripheral 1 is an example of an image processing apparatus and has functions such as a printing function, a copying function, and a scanning function. Optionally, the multifunction peripheral may further have a facsimile receiving/transmitting function in addition to these functions. For convenience of explanation, a vertical direction and a front-rear direction in the multifunction peripheral 1 are defined as indicated by the arrows in FIG. 1. Moreover, a left-hand side and a right-hand side to a viewer who stands in front of the multifunction peripheral 1 are defined as leftward side and rightward side, respectively, and a direction between the leftward side and the rightward side is defined as a left-right direction.

The multifunction peripheral 1 includes an image forming device 2 and an image reading device 9. The image forming device 2 has a printing function for forming an image on a sheet S. The image reading device 9 has a scanning function for reading an image of an original material and generating image data of a read image, which is the image having been read.

The image forming device 2 may form an image in, for example, an electrophotographic method. The image forming device 2 may be capable of printing monochrome images alone or may be capable of printing both color images and monochrome images. The image reading device 9 may be capable of reading both color images and monochrome images or may be capable of reading monochrome images alone.

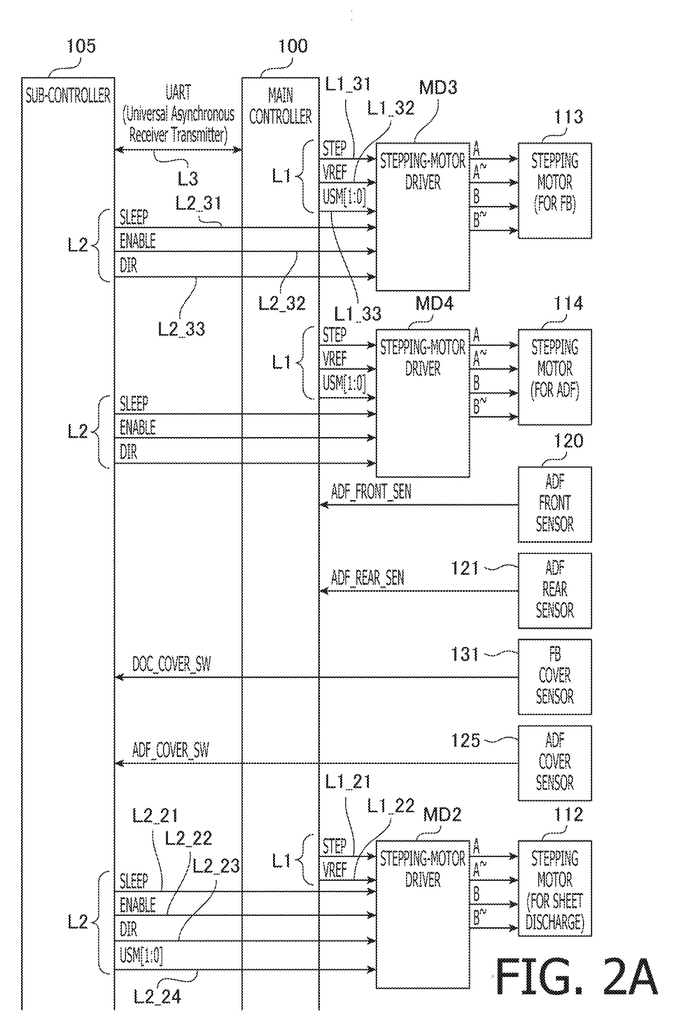

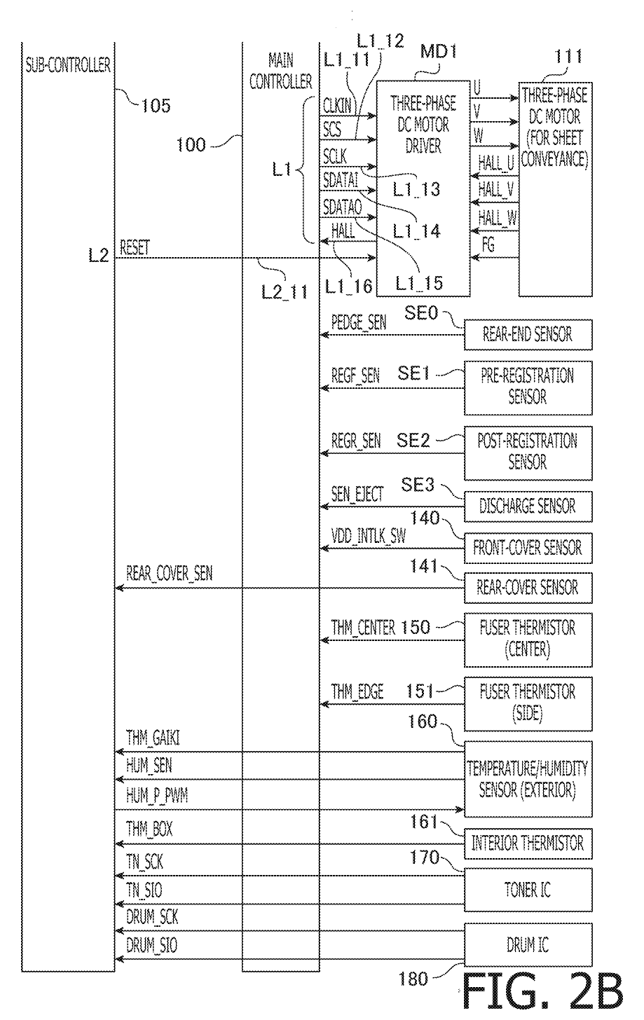

The multifunction peripheral 1 has an operation panel PA on a front side thereof. The operation panel PA includes, for example, a touch panel in which a touch-sensitive pad and a display are combined, and a key button unit. The operation panel PA may receive an operation by a user and output information received through the operation to a main controller 100 (see FIGS. 2A-2B). The user may instruct the multifunction peripheral 1 to print or copy an image by, for example, operating the operation panel PA. Optionally, the user may instruct the multifunction peripheral 1 to perform print-and-cutting or copy-and-cutting by operating the operation panel PA. Print-and- cutting refers to a job in which an image is printed on a sheet S by the image forming device 2 and the sheet S is cut thereafter. Copy-and-cutting refers to a job in which an image of an original material is read by the image reading device 9, the read image is printed on a sheet S by the image forming device 2, and the sheet S is cut thereafter.

The image forming device 2 includes a main body 20, a conveyer 3, a process unit 4, a fuser 6, and a cutter 10.

The main body 20 is formed in a substantially rectangular parallelepiped shape and includes a front cover 21, a rear cover 23, a feeder tray 31, a discharge tray 22, a conveyer path 201, and a duplex conveyer path 202. The front cover 21 is attached to a front face of the main body 20 in an openable/closable style. The rear cover 23 is attached to a rear face of the main body 20 in an openable/closable style. The feeder tray 31 is attached to a lower part of the main body 20 in an attachable/detachable style. On the feeder tray 31, one or more sheets S may be placed. The sheet S is a standard-sized sheet such as A4 size. The sheet S may be, for example, but not necessarily limited to, a paper medium such as plain paper or thick paper or may be, for another example, an OHP film. The discharge tray 22 is located in an upper area of the main body 20, and the sheet S on which an image has been formed is placed on the discharge tray 22.

The conveyer path 201 is a path in which the sheet S set in the feeder tray 31 is conveyed toward the discharge tray 22 via the process unit 4. The conveyer path 201 branches at a first branching position D1 into a first discharge path 201A and a second discharge path 201B. Therefore, the sheet S conveyed via the process unit 4 may be discharged to the discharge tray 22 either via the first discharge path 201A or via the second discharge path 201B.

The duplex conveyer path 202 is a path in which the sheet S, on one surface of which an image has been formed, is conveyed in a direction opposite to a conveying direction and conveyed again toward the process unit 4. The duplex conveyer path 202 branches from the conveyer path 201 at a second branching position D2 and merges with the conveyer path 201 at a merging position J located upstream of a pre-registration sensor SE1 in the conveying direction.

The conveyer 3 includes a pickup roller 33, a separation roller 34, a registration roller 35, a conveyer roller 36, a first discharge roller 85, a second discharge roller 86, a third discharge roller 87, a flapper 88, duplex conveyer rollers 38, 39, a three-phase DC motor 111(see FIG. 2B) for sheet conveyance, and a stepping motor 112 for sheet discharge (see FIG. 2A). Hereinafter, the three-phase DC motor 111 for sheet conveyance may be referred to as a sheet-conveyer motor 111, and the stepping motor 112 for sheet discharge may be referred to as a sheet-discharge motor 112.

The pickup roller 33 picks up the sheet S, which is lifted upward by a sheet pressing plate 32 in the feeder tray 31, and conveys the sheet S toward the conveyer path 201. The separation roller 34 separates the sheet S picked up by the pickup roller 33 from the other sheets S in the feeder tray 31.

The registration roller 35 is disposed upstream of the process unit 4 in the conveyer path 201. The registration roller 35 aligns a leading edge of the sheet S and conveys the sheet S toward the process unit 4. The conveyer roller 36 conveys the sheet S, which has passed through the fuser 6, toward the first discharge roller 85 or the third discharge roller 87.

The first discharge roller 85 and the second discharge roller 86 are disposed in the first discharge path 201A. The first discharge roller 85 and the second discharge roller 86 are roller pairs, each including a driving roller and a driven roller. The first discharge roller 85 is disposed upstream of a cutter position B, at which a cutter 10 is disposed, and the second discharge roller 86 is disposed downstream of the cutter position B.

The first discharge roller 85 and the second discharge roller 86 discharge the sheet S at the discharge tray 22 by rotating forward. Forward rotation is a rotation to convey the sheet S in the conveying direction, and corresponds to a counterclockwise rotation about an axis along the left-right direction of the main body 20 in a view from the left side of the multifunction peripheral 1 as shown in FIG. 1.

On the other hand, the third discharge roller 87 is disposed in the second discharge path 201B. The third discharge roller 87 is another roller pair including a driving roller and a driven roller. The third discharge roller 87 discharges the sheet S at the discharge tray 22 by rotating forward. Further, the third discharge roller 87 conveys the sheet S to the duplex conveyer path 202 by rotating in a reverse direction, which is opposite to the forward rotation. Reverse rotation is a rotation to convey the sheet S in a direction opposite to the conveying direction, and corresponds to a clockwise rotation about the axis along the left-right direction of the main body 20 in the view from the left side of the multifunction peripheral 1 as shown in FIG. 1.

In the duplex conveyer path 202, the duplex conveyer rollers 38, 39 are disposed.

The duplex conveyer rollers 38, 39 convey the sheet S conveyed to the duplex conveyer path 202 toward the process unit 4. By the duplex conveyer rollers 38, 39, the sheet S on which an image has been formed on one side thereof is conveyed back toward the process unit 4 via the duplex conveyer path 202, thereby enabling images to be formed on both sides of the sheet S.

The process unit 4 is configured to form an image on the sheet S and is housed in the main body 20. The process unit 4 includes a drum cartridge 5 and a laser unit 7. The drum cartridge 5 includes a photosensitive drum 51, a toner container 57, a supplying roller 56, a developing roller 55, a charger 52, a transfer roller 53, and a pinch roller 54. The drum cartridge 5 is removable from the main body 20 by opening the front cover 21. The pinch roller 54 in the drum cartridge 5 faces the registration roller 35. The pinch roller 54 is rotated by the rotation of the registration roller 35 and conveys the sheet S in cooperation with the registration roller 35.

The photosensitive drum 51 conveys the sheet S in the conveying direction by rotating clockwise by a driving force output from the sheet-conveyer motor 111 (see FIG. 2A). For the photosensitive drum 51, forward rotation to convey the sheet S in the conveying direction is a clockwise rotation in the view from the left side of the multifunction peripheral 1 as shown in FIG. 1. The toner container 57 may contain a toner therein. The supplying roller 56 supplies the toner in the toner container 57 to the developing roller 55. A charger 52 is a scorotron-typed charger and uniformly charges a surface of the photosensitive drum 51. Optionally, the charger 52 may be a charging roller.

At a position to face the photosensitive drum 51, the transfer roller 53 is disposed.

The transfer roller 53 forms a transfer nip TN with the photosensitive drum 51 in the conveyer path 201. Optionally, a transfer belt may be used in place of the transfer roller 53.

The main body 20 includes a laser unit 7 at an upper area inside thereof. The laser unit 7 includes a polygon mirror, a laser emitter, a polygon motor, a lens, and a mirror, which are not shown. The laser unit 7 scans the surface of the photosensitive drum 51 with laser light emitted from a laser emitter 132 according to the image data, thereby exposing the surface of the photosensitive drum 51 to the laser light.

By being exposed to the laser light in the laser unit 7, an electrostatic latent image based on the image data is formed on the surface of the photosensitive drum 51. The developing roller 55 supplies the toner to the electrostatic latent image formed on the surface of the photosensitive drum 51, thereby forming a toner image on the surface of the photosensitive drum 51.

To the transfer roller 53, a transfer voltage is applied by a voltage applying unit (not shown). As the sheet S is conveyed through the position between the transfer roller 53 and the photosensitive drum 51, the transfer roller 53 transfers the toner image formed on the surface of the photosensitive drum 51 to the sheet S passing through the transfer nip TN. As such, an image is formed on the sheet S.

On a downstream side of the process unit 4 in the conveyer path 201, the fuser 6 is disposed. The fuser 6 includes a heating roller 61, a pressure roller 62, a heater (not shown), and fuser thermistors 150, 151 (see FIG. 2B). The heating roller 61 heats the sheet S. The pressure roller 62 forms a nip N with the heating roller 61 and applies pressure to the sheet S. The pressure roller 62 rotates counterclockwise by a driving force from the sheet-conveyer motor 111. For the pressure roller 62, forward rotation, which conveys the sheet S in the conveying direction, is counterclockwise in the view from the left side of the multifunction peripheral as shown in FIG. 1.

The heater may be, for example, a halogen heater and heats the heating roller 61. The fuser thermistor 150 is located near a central portion of the heating roller 61 and detects temperature of the central portion of the heating roller 61. The fuser thermistor 151 is located near one end of the heating roller 61 and detects temperature of the one end portion of the heating roller 61. The fuser thermistors 150, 151 output signals corresponding to the detected temperatures to the main controller 100 (see FIG. 2B). Optionally, as the fuser thermistor 151, a thermistor to detect the temperatures at both end portions of the heating roller 61 may be used.

The fuser 6 heats the sheet S with the heating roller 61 and rotates the pressure roller 62, thereby conveying the sheet S while applying pressure through the heating roller 61 and the pressure roller 62, and fixes the image formed on the sheet S by the process unit 4 onto the sheet S.

Note that the fuser 6 may not necessarily be limited to the above configuration having the heating roller 61, the pressure roller 62, and the heater. For example, the fuser 6 may be in a configuration including a heater, a nip board that receives radiant heat from the heater, a heating belt rotating around the nip board, and a pressure roller.

For another example, the fuser 6 may be in a configuration including a substrate on which a heat-generating pattern is formed, a belt rotating around the substrate, and a pressure roller, wherein the substrate and the belt are in contact with each other. For another example, the fuser 6 may be in a configuration including a heating roller, a heater, and a pressure belt.

At the cutter position B between the first discharge roller 85 and the second discharge roller 86 in the first discharge path 201A, the cutter 10 is disposed. For cutting the sheet S, the multifunction peripheral 1 stops rotation of the first discharge roller 85 and the second discharge roller 86 when a cutting position on the sheet S reaches the cutter position B. While the first discharge roller 85 and the second discharge roller 86 pause without rotating, the multifunction peripheral 1 cuts the sheet S at the cutting position located at the cutter position B with the cutter 10.

It should be noted that the length of the second discharge path 201B is designed to be shorter than the length of the first discharge path 201A. This is to enable the sheet S to be discharged outside of main body 20 promptly when the sheet S with the image formed thereon is not cut.

Next, a part of the electrical configuration of the multifunction peripheral 1 will be described with reference to FIGS. 2A-2B. As shown in FIGS. 2A-2B, the multifunction peripheral 1 includes the main controller 100 and the sub-controller 105. Both the main controller 100 and the sub-controller 105 include, for example, an ASIC (Application Specific Integrated Circuit) and perform overall controls of the respective parts of the multifunction peripheral 1. However, the control performed by the main controller 100 and the control performed by the sub-controller 105 are separated from each other. The sub-controller 105 is added due to a reason such that the number of terminals and internal functions provided in the main controller 100 alone are insufficient for controlling all of the devices in the multifunction peripheral 1. That is, the sub-controller 105 is provided with a function as an externally expanded controller. In order to reduce manufacturing cost while adding the externally expanded controller, a less expensive controller than the main controller 100 is adopted as the sub-controller 105. Generally, a price of a controller is substantially proportional to its processing capability; therefore, the processing capability of the sub-controller 105 is lower than that of the main controller 100. The processing capability is substantially proportional to an operating clock frequency. For example, while the operating clock frequency of the sub-controller 105 may be 20 MHz, the operating clock frequency of the main controller 100 may be 300 MHz. Note that the values of the respective operating clock frequencies are merely examples, and controllers with other operating clock frequencies may be adopted.

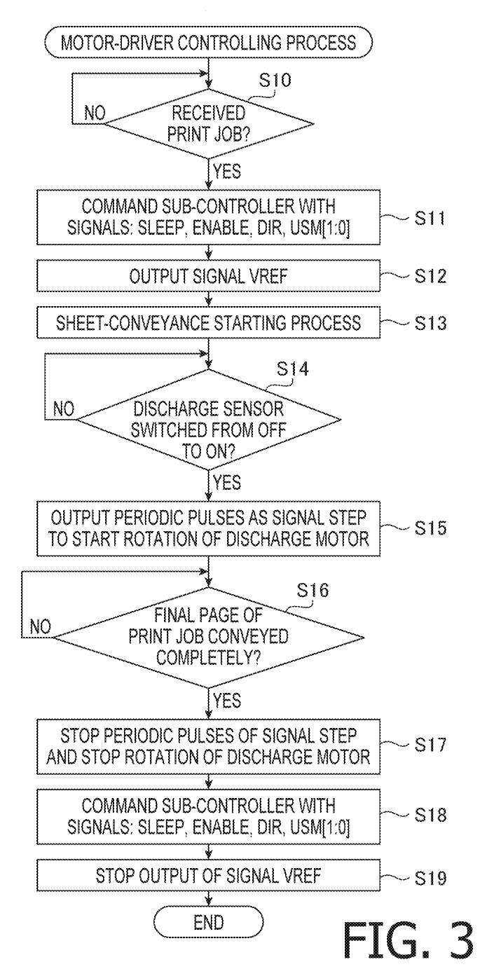

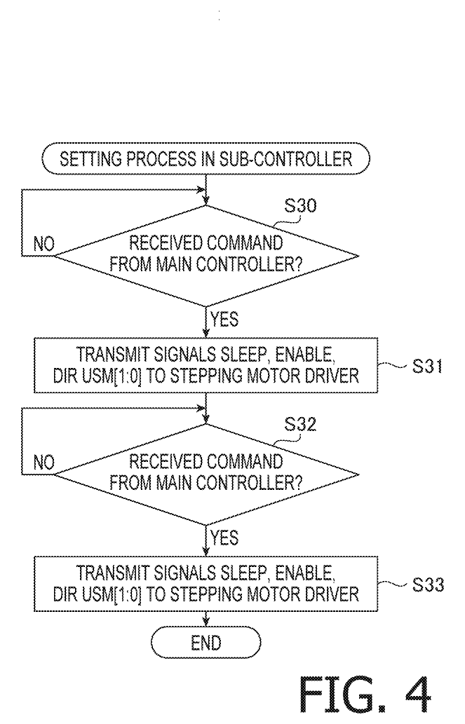

As shown in FIG. 2A, the main controller 100 and the sub-controller 105 are connected via a third signal line L3 and communicate with each other by UART (Universal Asynchronous Receiver Transmitter). Meanwhile, examples of contents to be communicated between the main controller 100 and the sub-controller 105 via the third signal line L3 will be described later with reference to FIGS. 3-4.

As shown in FIGS. 2A-2B, the main controller 100 is further connected to motor drivers MD1-MD4 via first signal lines L1. The sub-controller 105 is also connected to the motor drivers MD1-MD4 via second signal lines L2.

The motor driver MD1 is connected to the sheet-conveyer motor 111 and controls the sheet-conveyer motor 111 based on control signals from the main controller 100 and the sub-controller 105. The sheet-conveyer motor 111 outputs a driving force to the pickup roller 33, the registration roller 35, the conveyer roller 36, the duplex conveyer rollers 38, 39, the pressure roller 62, and the drum cartridge 5. When the main controller 100 and the sub-controller 105 drive the sheet-conveyer motor 111 for forward rotation via the motor driver MD1, a driving force output from the sheet-conveyer motor 111 is transmitted to the conveyer roller 36, the pressure roller 62, the photosensitive drum 51, the developing roller 55, the pickup roller 33, and the registration roller 35. Accordingly, the conveyer roller 36, the pressure roller 62, the photosensitive drum 51, the developing roller 55, the pickup roller 33, and the registration roller 35 rotate in the direction for conveying the sheet S in the conveying direction.

Specifically, the conveyer roller 36 and the pressure roller 62 rotate counterclockwise in the view from the left side of the multifunction peripheral 1 as shown in FIG. 1. The photosensitive drum 51 rotates clockwise. The developing roller 55 rotates counterclockwise. The pickup roller 33 rotates counterclockwise. The registration roller 35 rotates counterclockwise.

On the other hand, even when the main controller 100 and the sub-controller 105 drive the sheet-conveyer motor 111 for reverse rotation via the motor driver MD1, the conveyer roller 36, the pressure roller 62, the drum cartridge 5, the pickup roller 33, and the registration roller 35 are configured not to receive the driving force.

Further, the main controller 100 and the sub-controller 105 drive the sheet-conveyer motor 111 for forward rotation, thereby transmitting the driving force to the duplex conveyer roller 38 and the duplex conveyer roller 39 to rotate the duplex conveyer roller 38 and the duplex conveyer roller 39 clockwise. On the other hand, the main controller 100 and the sub-controller 105 drive the sheet-conveyer motor 111 for reverse rotation, thereby transmitting the driving force to the duplex conveyer roller 38 and the duplex conveyer roller 39 to rotate the duplex conveyer roller 38 and the duplex conveyer roller 39 clockwise.

As described above, the sheet-conveyer motor 111 is composed of the three-phase DC motor; therefore, the motor driver MD1 is a three-phase DC motor driver. The first signal line L1 connecting the main controller 100 and the motor driver MD1 includes a CLKIN signal line L1_11, an SCS signal line L1_12, an SCLK signal line L1_13, an SDATAI signal line L1_14, an SDATAO signal line L1_15, and a HALL signal line L1_16. A CLKIN signal transmitted via the CLKIN signal line L1_11 is a rotational speed command signal. A signal SCS transmitted via the SCS signal line L1_12 is a serial device selection signal. A signal SCLK transmitted via the SCLK signal line L1_13 is a serial communication clock signal. A signal SDATAI transmitted via the SDATAI signal line L1_14 is a serial communication input signal. A signal SDATAO transmitted via the SDATAO signal line L1_15 is a serial communication output signal. A signal HALL received via the HALL signal line L1_16 is a sensing signal from a Hall element. The second signal lines L2 connecting the sub-controller 105 and the motor driver MD1 include a RESET signal line L2_11. A RESET signal transmitted via the RESET signal line L2_11 is a reset signal. Note that detailed descriptions of each control signal from the main controller 100 and the sub-controller 105 and specific controlling processes performed by the motor driver MD1 on the sheet-conveyer motor 111 based on these control signals are herein omitted for the following reasons. That is, in the present embodiment, a common three-phase DC motor and a common three-phase DC motor driver are used, rather than anything unique. Further, a feature of the present embodiment may be found in selections of signal lines that connect the main controller 100 and the motor driver MD1 and connection lines that connect the sub-controller 105 and the motor driver MD1. In other words, the present embodiment may feature determining of role assignment between the main controller 100 and the sub-controller 105 with regard to the control over the motor driver MD1.

As such, among the control signals to the motor driver MD1, the signal RESET alone is output from the sub-controller 105, and all the others are output from or input to the main controller 100, for the following reason. That is, since the sheet-conveyer motor 111 needs to change its rotational speed while being driven, values of the control signals to the motor driver MD1 need to be switched frequently. Therefore, almost all of the control signals to the motor driver MD1 are assigned to the main controller 100, which has the higher processing capability. On the other hand, the RESET signal is output to the motor driver MD1 before the sheet-conveyer motor 111 is driven, and the value output to the motor driver MD1 is not switched while the sheet-conveyer motor 111 is being driven. Therefore, the RESET signal is assigned to the sub-controller 105 having the lower processing capability.

The motor driver MD2 is connected to the sheet-discharge motor 112 and controls driving of the sheet-discharge motor 112 based on the control signals from the main controller 100 and the sub-controller 105. The motor driver MD2 controls driving of the sheet-discharge motor 112 according to the control signals from the main controller 100 and the sub-controller 105. The sheet-discharge motor 112 is, as described above, a stepping motor, and transmits the driving force to the first discharge roller 85, the second discharge roller 86, and the third discharge roller 87. When the main controller 100 and the sub-controller 105 drive the sheet-discharge motor 112 for forward rotation via the motor driver MD2, the first discharge roller 85, the second discharge roller 86, and the third discharge roller 87 are rotated counterclockwise. Accordingly, the sheet S is discharged to the discharge tray 22 via the first discharge path 201A or the second discharge path 201B. On the other hand, when the main controller 100 and the sub-controller 105 drive the sheet-discharge motor 112 for reverse rotation, the first discharge roller 85, the second discharge roller 86, and the third discharge roller 87 are rotated clockwise. Accordingly, the sheet S in the second discharge path 201B is conveyed in the direction opposite to the conveying direction.

The sheet-discharge motor 112 is a stepping motor; therefore, the motor driver MD2 is a stepping-motor driver. The first signal line L1 connecting the main controller 100 and the motor driver MD2 includes a STEP signal line L1_21 and a VREF signal line L1_22. In the present embodiment, a STEP signal transmitted via the STEP signal line L1_21 is a rotation step command signal. A VREF signal transmitted via the VREF signal line L1_22 is a current amount command signal. Further, the second signal line L2 connecting the sub-controller 105 and the motor driver MD1 includes a SLEEP signal line L2_21, an ENABLE signal line L2_22, a DIR signal line L2_23, and a USM[1:0] signal line L2_24. According to the present embodiment, a SLEEP signal transmitted via the SLEEP signal line L2_21 is a driver enable/disable command signal. A signal ENABLE transmitted via the ENABLE signal line L2_22 is an excitation enable/disable signal. A signal DIR transmitted via the DIR signal line L2_23 is a rotation direction command signal. A signal USM[1:0] transmitted via the USM[1:0] signal line L2_24 is an excitation phase command signal. Note that detailed descriptions of these control signals from the main controller 100 and the sub-controller 105 and specific controlling processes performed by the motor driver MD2 on the sheet-discharge motor 112 based on the control signals are herein omitted for the following reasons. That is, in the present embodiment, a common stepping motor and a common stepping-motor driver are used, rather than anything unique. Further, a feature of the present embodiment may be found in selections of signal lines that connect the main controller 100 and the motor driver MD2 and connection lines that connect the sub-controller 105 and the motor driver MD2. In other words, the present embodiment may feature determining of role assignment between the main controller 100 and the sub-controller 105 with regard to the control over the motor driver MD2.

As such, among the control signals to the motor driver MD2, the signals STEP and VREF are output from the main controller 100, and the signals SLEEP, ENABLE, DIR, and USM[1:0] are output from the sub-controller 105 for the following reason. That is, since the sheet-discharge motor 112 needs to change its rotational speed while being driven, values of control signals to the motor driver MD2 need to be switched frequently. Therefore, among the control signals to the motor driver MD2, the signals STEP and VREF necessary for changing the rotational speed are assigned to the main controller 100, which has the higher processing capability. On the other hand, the signals SLEEP, ENABLE, DIR, and USM[1:0] are output to the motor driver MD2 before the sheet-discharge motor 112 is driven, and the values output to the motor driver MD2 are not switched while the sheet-discharge motor 112 is being driven. Therefore, the signals SLEEP, ENABLE, DIR, and USM[1:0] are assigned to the sub-controller 105, which has the lower processing capability.

The motor driver MD3 is connected to a stepping motor 113 for FB (flatbed) included in the image reading device 9.

The motor driver MD4 is connected to a stepping motor 114 for ADF (automatic document feeder) included in the image reading device 9.

Hereinafter, the stepping motor 113 for FB may be referred to as an FB motor 113, and the stepping motor 114 for ADF may be referred to as an ADF motor 114.

The image reading device 9 is configured to read an image on a document in either an FB reading mode, in which an unillustrated drive pulley is driven by the FB motor 113 to move an unillustrated CIS (contact image sensor) unit in a sub-scanning direction to read an image on the document placed on a platen glass 91 (see FIG. 1), or an ADF reading mode, in which, with the CIS unit fixed stationary, an unillustrated conveyer roller is driven by the ADF motor 114 to convey the document to the CIS unit to read the image on the document. When the FB reading mode is selected, the motor driver MD3 controls driving of the FB motor 113 based on the control signals from the main controller 100 and the sub-controller 105. On the other hand, when the ADF reading mode is selected, the motor driver MD4 controls driving of the ADF motor 114 based on the control signals from the main controller 100 and the sub-controller 105.

The first signal line L1 connecting the main controller 100 and the motor driver MD3 includes, in addition to a STEP signal line L1_31 and a VREF signal line L1_32, a USM[1:0] signal line L1_33. Meanwhile, the second signal line L2 connecting the sub-controller 105 and the motor driver MD3 includes a SLEEP signal line L2_31, an ENABLE signal line L2_32, and a DIR signal line L2_33. Compared with the first signal line L1 connecting the main controller 100 and the motor driver MD2 and the second signal line L2 connecting the sub-controller 105 and the motor driver MD2, the first signal line L1 connecting the main controller 100 and the motor driver MD3 and the second signal line L2 connecting the sub-controller 105 and the motor driver MD3 are different in that the USM[1:0] signal line L2_24, which was included in the second signal line L2 connecting the sub-controller 105 and the motor driver MD2, is included in the first signal line L1 as the USM[1:0] signal line L1_33 connecting the main controller 100 and the motor driver MD3. This difference similarly applies to the first signal line L1 connecting the main controller 100 and the motor driver MD4 and the second signal line L2 connecting the sub-controller 105 and the motor driver MD4. This is because the FB motor 113 and the ADF motor 114 need to switch excitation phases while being driven.

Next, to which of the main controller 100 and the sub-controller 105, each of the controllable devices including sensors is connected will be described below.

An ADF front sensor 120 and an ADF rear sensor 121 are connected to the main controller 100. The ADF front sensor 120 and the ADF rear sensor 121 are required to accurately measure a conveyance timing of the sheet S while conveying the sheet S with the ADF. Therefore, a role to detect the output from the ADF front and rear sensors 120, 121 is assigned to the main controller 100.

On the other hand, an FB cover sensor 131 and an ADF cover sensor 125 are connected to the sub-controller 105. States of the FB cover sensor 131 and the ADF cover sensor 125 are detected independently of driving states of the FB motor 113 and the ADF motor 114. Therefore, a role to detect the outputs from the FB cover sensor 131 and the ADF cover sensor 125 is assigned to the sub-controller 105.

As shown in FIG. 2B, a rear-end sensor SE0, the pre-registration sensor SE1, a post-registration sensor SE2, a discharge sensor SE3, and a front-cover sensor 140 are connected to the main controller 100.

The rear-end sensor SE0 is a sensor disposed downstream of and in the vicinity of a separation roller 34 in the conveyer path 201, and may detect the sheet S passing thereby. For the rear-end sensor SE0, a sensor including an actuator that swings when the sheet S abuts thereon or an optical sensor may be employed. The rear-end sensor SE0 outputs an ON signal when the sheet S is passing thereby and outputs an OFF signal when the sheet S is not passing thereby. The pre-registration sensor SE1 is a sensor disposed upstream of the registration roller 35 in the conveyer path 201 and may detect the sheet S passing thereby. The pre-registration sensor SE1 has the same configuration as the rear-end sensor SE0. The post-registration sensor SE2 is a sensor disposed upstream of the fuser 6 in the conveyer path 201, specifically between the registration roller 35 and the transfer roller 53, and may detect the sheet S passing thereby. The post-registration sensor SE2 has the same configuration as the rear-end sensor SE0. The discharge sensor SE3 is disposed between the fuser 6 and the conveyer roller 36 in the conveyer path 201 and may detect the sheet S passing thereby. The discharge sensor SE3 has the same configuration as the rear-end sensor SE0.

The role to detect the sensor outputs from the rear-end sensor SE0, the pre-registration sensor SE1, the post-registration sensor SE2, and the discharge sensor SE3 is assigned to the main controller 100 as above for the following reason. That is, the rear-end sensor SE0, the pre-registration sensor SE1, the post-registration sensor SE2, and the discharge sensor SE3 are required to accurately measure the position of the sheet S being conveyed while the image forming device 2 is operating.

The front-cover sensor 140 is disposed in the vicinity of the front cover 21 and may detect opening and closing of the front cover 21. When the front cover 21 is opened while the image forming device 2 is operating, the operation of the image forming device 2 including the sheet-conveyer motor 111 and the sheet-discharge motor 112 needs to be stopped, and an error alert may need to be displayed. As such, the state of the front cover 21 needs to be detected accurately and promptly. Therefore, the role to detect the sensor output from the front-cover sensor 140 is assigned to the main controller 100.

A rear-cover sensor 141 is connected to the sub-controller 105. The rear-cover sensor 141 is disposed in the vicinity of the rear cover 23 (see FIG. 1) and detects opening and closing of the rear cover 23. Even when the rear cover 23 is opened while the image forming device 2 is operating, neither the operation of the image forming device 2 is stopped, nor an error alert is displayed. Therefore, without the necessity to accurately or promptly detect the rear cover 23, the role of detecting the sensor output from the rear-cover sensor 141 is assigned to the sub-controller 105. A case where the rear cover 23 is opened while the image forming device 2 is operating may be, for example, when a user selects an operation so-called “straight sheet-discharge.” The straight sheet-discharge means that a sheet S, after passing through the conveyer roller 36, is discharged rearward from the main body 20 through the rear cover 23 in the open state without being conveyed by the first and third discharge rollers 85, 87. The straight sheet-discharge may be selected when printing an image on a thick paper.

The fuser thermistors 150, 151 are connected to the main controller 100. Temperature outputs from the fuser thermistors 150, 151 are used for feedback control of the heater. In order to accurately and promptly perform this feedback control, the temperatures from the fuser thermistors 150, 151 need to be detected accurately and promptly. Therefore, the role to detect the temperature outputs from the fuser thermistors 150, 151 is assigned to the main controller 100.

A temperature/humidity sensor 160, an interior thermistor 161, a toner IC 170, and a drum IC 180 are connected to the sub-controller 105. The temperature and humidity outside or inside the multifunction peripheral 1 are acquired at a slow acquisition interval, for example, on the order of several hundred msec to one thousand msec. Therefore, the role to detect the outputs from the temperature/humidity sensor 160 and the interior thermistor 161 is assigned to the sub-controller 105. Frequency to access consumable ICs, including the toner IC 170 and the drum IC 180, is low; therefore, the role to detect outputs from these ICs is assigned to the sub-controller 105.

Hereinbelow, control of the multifunction peripheral 1 configured as described above, particularly controlling processes executed by the main controller 100 and the sub-controller 105, will be described in detail with reference to FIGS. 3-4.

FIG. 3 illustrates a procedure in a motor-driver controlling process executed by the main controller 100. The target to be controlled in the motor-driver controlling process is the motor driver MD2.

In FIG. 3, the main controller 100 waits until a print job is received (S10: NO).

When the print job is received (S10: YES), the main controller 100 commands the sub-controller 105 to set signals (S11). The signals to be set in S11 are the signal SLEEP, the signal ENABLE, the signal DIR, and the signal USM[1:0]. In other words, the main controller 100 commands the sub-controller 105 in UART through the third signal line L3 to set the signal SLEEP, the signal ENABLE, the signal DIR, and the signal USM[1:0] with respective designated values.

FIG. 4 illustrates a procedure in a setting process executed by the sub-controller 105. When the sub-controller 105 receives the command from the main controller 100 (S30: YES), the sub-controller 105 transmits signals to the motor driver MD2 (S31). The signals to be transmitted in S31 are the signal SLEEP, the signal ENABLE, the signal DIR, and the signal USM[1:0]. As the main controller 100 transmits the command in which the values for these signals are designated, the sub-controller 105 transmits signals including values corresponding to the command to the motor driver MD2.

Returning to FIG. 3, the main controller 100 next outputs the signal VREF to the motor driver MD2 (S12). Accordingly, the sheet-discharge motor 112 enters a standby mode.

Next, the main controller 100 executes a sheet-conveyance starting process (S13). The sheet-conveyance starting process includes outputting signals including the signals CLKIN, SCS, SCLK, SDATAI, and SDATAO to the motor driver MD1 in order to start driving the sheet-conveyer motor 111.

Thereafter, the main controller 100 waits until output from the discharge sensor SE3 is switched from OFF to ON (S14: NO). When output from the discharge sensor SE3 is switched from OFF to ON (S14: YES), and the main controller 100 detects a leading edge of the sheet S being conveyed in the conveying direction via the discharge sensor SE3, the process proceeds to S15. In S15, the main controller 100 outputs periodic pulses as the signal STEP to the motor driver MD2 (S15). Accordingly, the sheet-discharge motor 112 starts rotating.

Next, the main controller 100 waits until conveyance of the sheet S with a final page in the print job is completed (S16: NO). When conveyance of the sheet S with the final page of the print job is completed (S16: YES), the main controller 100 stops the periodic pulses as the signal STEP having been output to the motor driver MD2 (S17). Accordingly, the sheet-discharge motor 112 stops rotating.

Next, the main controller 100 commands the sub-controller 105 to set signals (S18).

The signals to be set in S18 are the signal SLEEP, the signal ENABLE, the signal DIR, and the signal USM[1:0], similarly to S11. In other words, the main controller 100 commands the sub-controller 105 in UART through the third signal line L3 the signal SLEEP, the signal ENABLE, the signal DIR, and the signal USM[1:0] with the respective designated values. However, the values designated in S18 differ from those in S11 such that, in S11, the values are for starting the sheet-discharge motor 112, whereas in S18, the values are for stopping the sheet-discharge motor 112.

Further, the main controller 100 stops outputting the signal VREF to the motor driver MD2 (S19) and ends the motor-driver controlling process.

In S32 in the setting process in FIG. 4, when the sub-controller 105 receives a command from the main controller 100 (S32: YES), the sub-controller 105 transmits signals to the motor driver MD2 (S33). The signals to be transmitted in S33 are the signal SLEEP, the signal ENABLE, the signal DIR, and the signal USM[1:0], similarly to those in S31. As the main controller 100 transmits the command in which the values for these signals are designated, the sub-controller 105 transmits signals having values corresponding to the command to the motor driver MD2. Thereafter, the sub-controller 105 ends the setting process.

Note that, while the target to be controlled in the controlling processes shown in FIGS. 3-4 is the motor driver MD2, the other motor drivers MD1, MD3, MD 4 may be controlled similarly by applying the controlling processes in FIGS. 3-4 similarly and analogously.

As described above, the multifunction peripheral 1 according to the present embodiment includes the motors 111-114, the motor drivers MD1-MD4 connected to the motors 111-114 for driving the motors 111-114, the main controller 100 connected with the motor drivers MD1-MD4 via the plurality of first signal lines L1, and the sub-controller 105 having the lower processing capability than the processing capability of the main controller 100 and being connected with the motor drivers MD1-MD4 via at least one second signal line L2 and with the main controller 100 via at least one third signal line L3.

As such, in the multifunction peripheral 1 according to the present embodiment, the less expensive sub-controller 105 having the lower processing capability than the main controller 100 is used, thereby contributing to cost reduction when expanding the number of terminals of the controller.

Optionally, the signals transmitted via respective ones of the plurality of first signal lines L1 may be signals, of which values are switched while the motors 111-114 are being driven, and the signal transmitted via the at least one second signal line L2 may be a signal, of which value is switched less frequently than the value of the signals transmitted via the plurality of first signal lines L1.

As such, the signal processed by the sub-controller 105 may be a signal, of which value is switched less frequently than the signals transmitted via the first signal lines L1. Therefore, the sub-controller 105 may process the signal adequately.

Optionally, the signal transmitted via the at least one second signal line L2 may be a signal, of which value is not switched while the motors 111-114 are being driven.

As such, the sub-controller 105 may not need to switch values of the signals while the motors 111-114 are being driven. Therefore, a controller with lower processing capability may be employed as the sub-controller 105.

Optionally, the motors 112-114 may be stepping motors, the motor drivers MD2-MD4 may be stepping-motor drivers, and the plurality of first signal lines L1 may include at least a STEP signal line and a VREF signal line. The at least one second signal line L2 may include a plurality of signal lines at least including a SLEEP signal line, an ENABLE signal line, and a DIR signal line. The main controller 100 may be configured to transmit information related to the SLEEP signal, the ENABLE signal, and the DIR signal to the sub-controller 105 via the third signal line L3.

Accordingly, for controlling the motor drivers MD2-MD4, complex control may be assigned to the main controller 100, while simple control may be assigned to the sub-controller 105.

Optionally, the plurality of first signal lines L1 may further include a USM[1:0] signal line.

Accordingly, the role to control the signal USM[1:0] transmitted via the USM[1:0] signal line may be assigned to the main controller 100.

Optionally, the at least one second signal line L2 may further include a USM[1:0] signal line.

Accordingly, the role to control the signal USM[1:0] transmitted via the USM[1:0] signal line may be assigned to the sub-controller 105.

Optionally, the motor 111 may be a DC motor, the motor driver MD1 may be a DC motor driver, and the plurality of first signal lines L1 may include at least a CLKIN signal line L1_11, an SCS signal line L1_12, an SCLK signal line L1_13, an SDATAI signal line L1_14, an SDATAO signal line L1_15, and a HALL signal line L1_16. The at least one second signal line L2 may include at least a RESET signal line L2_11, and the main controller 100 is configured to transmit information related to a RESET signal to the sub-controller 105 via the at least one third signal line L3.

Accordingly, for controlling the motor driver MD1, complex control may be assigned to the main controller 100, while simple control may be assigned to the sub-controller 105.

Optionally, the main controller 100 may be connected with at least one of the sensors including the ADF front sensor 120, the ADF rear sensor 121, the rear-end sensor SE0, the pre-registration sensor SE1, the post-registration sensor SE2, the discharge sensor SE3, the front-cover sensor 140, and the fuser thermistors 150, 151.

The outputs from the ADF front sensor 120, the ADF rear sensor 121, the rear-end sensor SE0, the pre-registration sensor SE1, the post-registration sensor SE2, the discharge sensor SE3, the front-cover sensor 140, and the fuser thermistors 150, 151 are required to be detected promptly and accurately; therefore, the role to detect these outputs may be assigned to the main controller 100.

Optionally, the sub-controller 105 may be connected with at least one of the sensors including the FB cover sensor 131, the ADF cover sensor 125, the rear-cover sensor 141, the temperature/humidity sensor 160, and the interior thermistor 161.

The outputs from the FB cover sensor 131, the ADF cover sensor 125, the rear-cover sensor 141, the temperature/humidity sensor 160, and the interior thermistor 161 are not required to be detected promptly or accurately; therefore, the role to detect these signals may be assigned to the sub-controller 105.

Optionally, the sub-controller 105 may be connected with at least one of the toner IC 170 or the drum IC 180.

Frequency to access the consumable ICs, including the toner IC 170 and the drum IC 180, is low; therefore, the role to detect outputs from these ICs may be assigned to the sub-controller 105.

While the present disclosure described in conjunction with the example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the disclosure, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential modifications according to aspects of the present disclosure are provided below.

For example, in the above embodiment, the multifunction peripheral 1 is described as an example of an image processing apparatus; however, the image processing apparatus is not limited to the multifunction peripheral 1, but may be a standalone printer or copier.

For another example, in the above embodiment, the number of terminals of the main controller 100 is expanded by adding one sub-controller 105 to the main controller 100. However, the number of controllers to be added is not limited to one, but may be two or more.

What is claimed is:

1. An image processing apparatus, comprising:
a motor;
a motor driver connected to the motor for driving the motor;
a main controller connected with the motor driver via a plurality of first signal lines; and
a sub-controller having lower processing capability than processing capability of the main controller, the sub-controller being connected with the motor driver via at least one second signal line and with the main controller via at least one third signal line.

2. The image processing apparatus according to claim 1,
wherein a signal transmitted via any of the plurality of first signal lines is a signal, of which value is switched while the motor is being driven, and
wherein a signal transmitted via the at least one second signal line is a signal, of which value is switched less frequently than the value of the signal transmitted via any of the plurality of first signal lines.

3. The image processing apparatus according to claim 2, wherein the signal transmitted via the at least one second signal line is a signal, of which value is not switched while the motor is being driven.

4. The image processing apparatus according to claim 2,
wherein the motor is a stepping motor,
wherein the motor driver is a stepping-motor driver,
wherein the plurality of first signal lines at least includes a STEP signal line and a VREF signal line,
wherein the at least one second signal line includes a plurality of signal lines, at least including a SLEEP signal line, an ENABLE signal line, and a DIR signal line, and
wherein the main controller is configured to transmit information related to a SLEEP signal, an ENABLE signal, and a DIR signal to the sub-controller via the at least one third signal line.

5. The image processing apparatus according to claim 4, wherein the plurality of first signal lines further include a USM[1:0] signal line.

6. The image processing apparatus according to claim 4, wherein the at least one second signal line further includes a USM[1:0] signal line.

7. The image processing apparatus according to claim 2,
wherein the motor is a DC motor,
wherein the motor driver is a DC motor driver,
wherein the plurality of first signal lines at least include a CLKIN signal line, an SCS signal line, an SCLK signal line, an SDATAI signal line, an SDATAO signal line, and a HALL signal line,
wherein the at least one second signal line at least includes a RESET signal line, and
wherein the main controller is configured to transmit information related to a RESET signal to the sub-controller via the at least one third signal line.

8. The image processing apparatus according to claim 1, wherein the main controller is connected with at least one of sensors including an ADF front sensor, an ADF rear sensor, a rear-end sensor, a pre-registration sensor, a post-registration sensor, a discharge sensor, a front-cover sensor, and a fuser thermistor.

9. The image processing apparatus according to claim 1, wherein the sub-controller is connected with at least one of sensors including an FB cover sensor, an ADF cover sensor, a rear-cover sensor, a temperature/humidity sensor, and an interior thermistor.

10. The image processing apparatus according to claim 1, wherein the sub-controller is connected with at least one of a toner IC or a drum IC.
